(19) United States
(12) Patent Application Publication
(10) Pub. No.: US 2024/0132235 A1
(43) Pub. Date: Apr. 25, 2024

(54) AERIAL VEHICLE

(71) Applicant: AERONEXT INC., Tokyo (JP)

(72) Inventor: Yoichi SUZUKI, Tokyo (JP)

(21) Appl. No.: 17/769,599

(22) PCT Filed: Oct. 15, 2019
(86) PCT No.: PCT/JP2019/040598

§ 371 Date: Apr. 14, 2022

(51) Int. Cl. B64U 10/16; B64U 30/293

(52) U.S. Cl. CPC B64U 10/16; B64U 30/293; B64U 30/291

(57) ABSTRACT

[Problem to be Solvent] To provide an aerial vehicle that can efficiently reduce the horizontal dimensions of the airframe. [Solution] The aerial vehicle according to the present invention includes two first frames arranged in a second direction intersecting a first direction, with the first direction being longitudinal, two second frames arranged in the first direction by overlapping the two first frames, with the second direction being longitudinal, first rotor blades mounted to both ends of the first frame, and second rotor blades mounted to both ends of the second frame, wherein the second frame is provided with a hinge part capable of folding the second frame at a midway thereof.

### TECHNICAL FIELD

The present invention relates to an aerial vehicle.

### BACKGROUND ART

In recent years, an aerial vehicle such as a drone or an unmanned aerial vehicle (UAV) (hereinafter collectively referred to as “aerial vehicle”) has spread through the market. For example, a multicopter-type having a plurality of rotor blades can be mentioned (for example, see Patent Literature 1).

### PRIOR ART

### Patent Literature

[Patent Literature 1] Japanese Unexamined Patent Application Publication No. 2013-129301

### SUMMARY OF THE INVENTION

### Technical Problem

In the aerial vehicle of Patent Literature 1, the arm and the rotor occupy most of the dimensions in a horizontal direction of the airframe, which is a factor of lowering the space efficiency during storage.

Therefore, it is an object of the present invention to provide an aerial vehicle capable of efficiently reducing the horizontal dimensions of the airframe.

### Technical Solution

According to the present invention, there is provided an aerial vehicle comprising: two first frames arranged in a second direction intersecting a first direction, with the first direction being longitudinal, two second frames arranged in the first direction by overlapping the two first frames, with the second direction being longitudinal, first rotor blades mounted to both ends of the first frame, and second rotor blades mounted to both ends of the second frame, wherein the second frame is provided with a hinge part capable of folding the second frame at a midway thereof.

### Advantageous Effects

According to the present invention, an aerial vehicle that can efficiently reduce the horizontal dimensions of the airframe can be provided.

### BRIEF DESCRIPTION OF THE DRAWINGS

FIG. 1 is a plan view of an aerial vehicle according to the present embodiment;

FIG. 2 is a side view of an aerial vehicle according to the present embodiment;

FIG. 3 is a plan view showing a state in which the second frame is folded;

FIG. 4 is a side view showing a state in which the second frame is folded;

FIG. 5 is a general functional block diagram of an aerial vehicle;

FIG. 6 is showing a first modification of the frame structure in an aerial vehicle of the present invention (Part 1);

FIG. 7 is showing a first modification of the frame structure in an aerial vehicle of the present invention (Part 2); and

FIG. 8 is showing a second modification of the frame structure in an aerial vehicle of the present invention.

### DETAILED DESCRIPTION OF THE EMBODIMENTS

The contents of the embodiment of the present invention will be listed and described. An aerial vehicle according to an embodiment of the present invention has the following configuration.

### [Item 1]

An aerial vehicle comprising:
two first frames arranged in a second direction intersecting a first direction, with the first direction being longitudinal;
two second frames arranged in the first direction by overlapping the two first frames, with the second direction being longitudinal;
first rotor blades mounted to both ends of the first frame; and
second rotor mounted to both ends of the second frame,
wherein the second frame is provided with a hinge part capable of folding the second frame at a midway thereof.

### [Item 2]

The aerial vehicle according to Item 1,
wherein, it is folded in pairs when the second frame is in a folded position; and
wherein the pair is comprising a first arm and a second arm that are folded so as to overlap each other when viewed for a side.

### [Item 3]

The aerial vehicle as in Item 1 or 2,
wherein the two first frames are laid horizontally across the two second frames in a parallel cross pattern.

### Details of Embodiments

Hereinafter, a flight vehicle according to the embodiments of the present invention will be described with reference to the accompanying drawings.

### Details of Embodiments According to the Present Invention

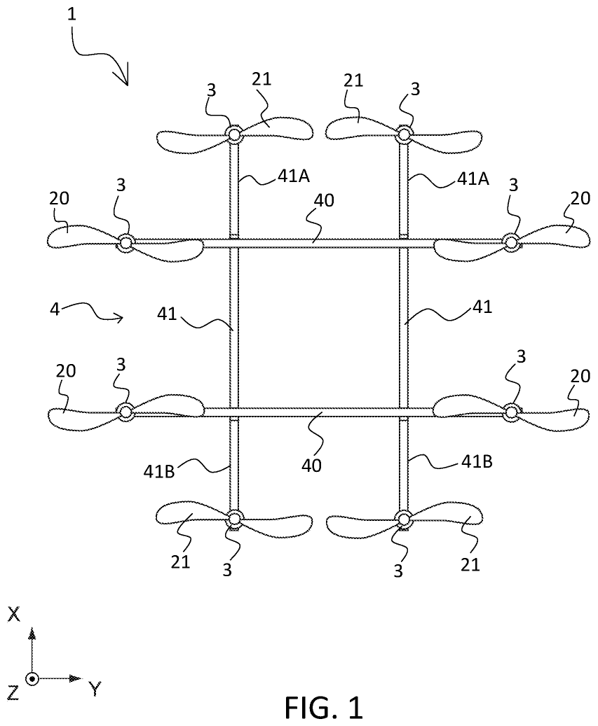

As shown in FIG. 1, an aerial vehicle according to an embodiment of the present invention includes a rotary blade 2, a motor 3 for rotating the rotary blade 2, and a frame 4 to which the motor 3 is mounted.

The rotary blade 2 receives an output from the motor 3 and rotates. The rotation of the rotor blade 2 generates a propulsive force for taking off the aerial vehicle 1 from the departure point, moving it horizontally, and landing it at the destination. Further, the rotary blade 2 can rotate to the right direction, stop, and rotate to the left direction.

The rotary blade 2 of the present invention has an elongated blade shape. Any number of blades (rotors) (e.g., 1, 2, 3, 4, or more blades) may be used. Further, the shape of the blade can be any shape such as a flat shape, a curved shape, a twisted shape, a tapered shape, or a combination thereof. Further, the shape of the blade can be changed (for example, stretched, folded, bent, etc.). The blades may be symmetrical (having the same upper and lower surfaces) or asymmetric (having different shaped upper and lower surfaces). The blades can be formed into a geometric shape suitable for generating dynamic aerodynamic forces (e.g., lift, thrust) as an air wheel, wing, or blade when moving in the air. The geometric shape of the blades can be appropriately selected to optimize the dynamic air characteristics of the blades, such as increasing lift and thrust and reducing drag.

The motor 3 allows the rotation of the rotary blade 2. For example, the drive unit can include an electric motor, an engine, or the like. The blade can be driven by a motor and rotate around the axis of rotation of the motor (e.g., long axis of the motor) in a clockwise and/or counterclockwise direction.

The blades can all rotate in the same direction or can rotate independently. Some of the blades rotate in one direction and the other blades rotate in the other direction. The blades can all rotate at the same rotation speed, or can rotate at different rotation speeds. The rotation speed can be automatically or manually determined based on the dimensions (for example, size, weight) and control state (speed, moving direction, etc.) of the moving body.

The frame 4 is a member that supports the corresponding motor 3 and rotary blade 2, respectively. The frame 4 may be provided with a color-developing body such as an LED to indicate the flight state, flight direction, and the like of the rotary wing aircraft. The frame 4 according to the present embodiment can be formed of a material appropriately selected from carbon, stainless steel, aluminum, magnesium, or the like, an alloy or combination thereof.

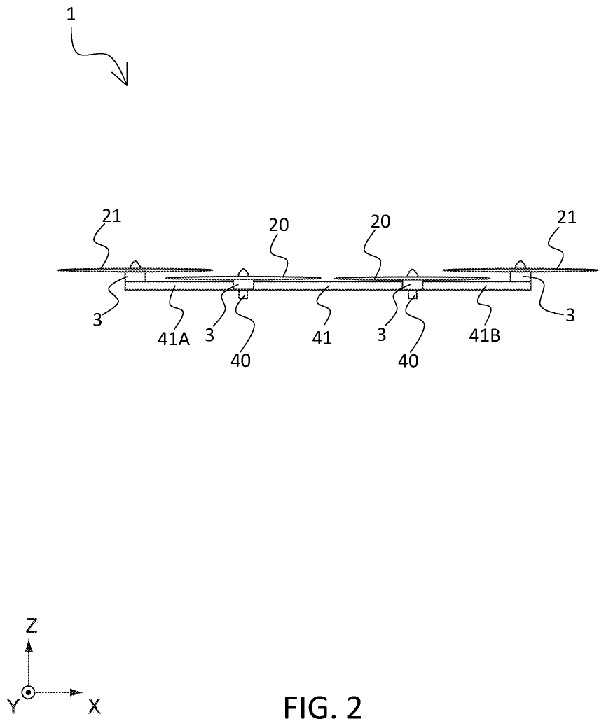

As shown in FIGS. 1 and 2, the frame 4 includes two first frames 40 and 40, and two second frames 41 and 41. The first frames 40 and 40 are laid horizontally across the second frames 41 and 41 in a parallel cross pattern. The first frames 40 and 40 and the second frames 41 and 41 might be connected to each other by a conventionally known method.

As shown in FIG. 1, the first frames 40 and 40 are arranged at a predetermined interval along the X direction (second direction) intersecting the first direction, with the Y direction (first direction) being longitudinal. The first rotary blades 20 are mounted at both ends of the first frames 40 and 40.

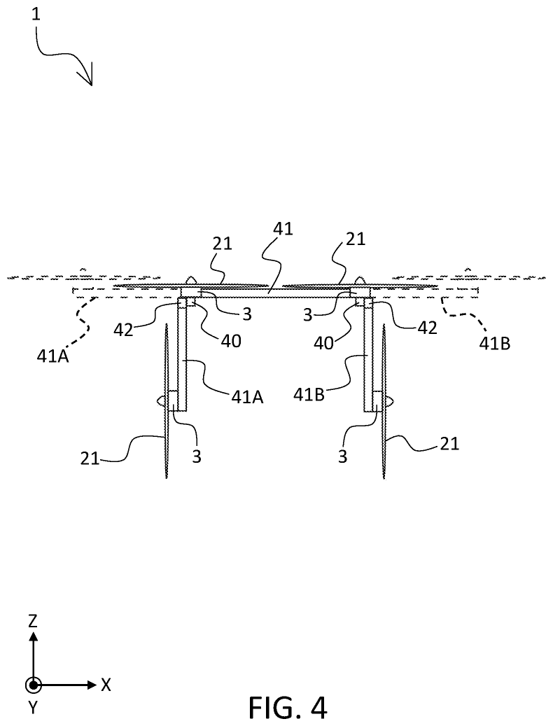

As shown in FIG. 1, the second frames 41 and 41 are arranged at a predetermined interval along the Y direction (first direction) by overlapping the two first frames 40 and 40, with the X direction (second direction) being longitudinal. Second rotary blades 21 are mounted at both ends of the second frames 41 and 41. As shown in FIG. 4, the second frames 41 and 41 are provided with a hinge part 42 capable of folding the second frames 41 and 41 at a midway thereof.

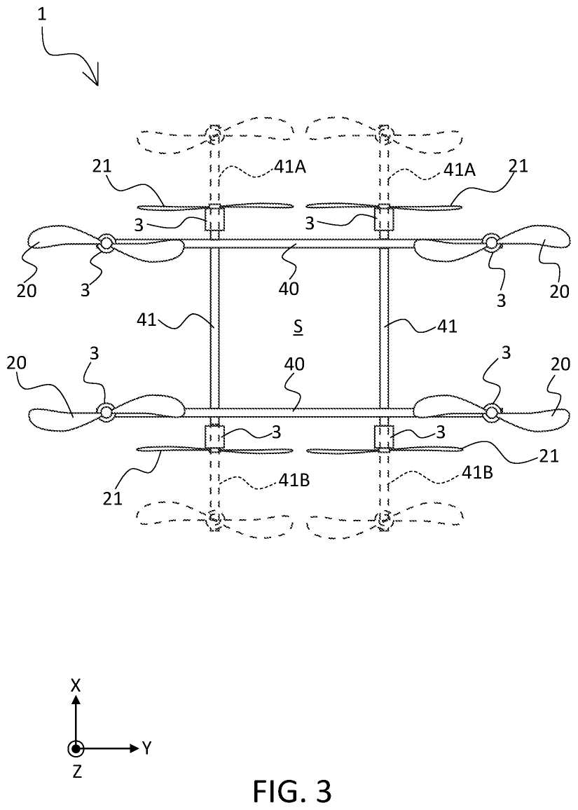

As shown in FIGS. 3 and 4, when the second frames 41 and 41 are in a folded position, the second frames 41 and 41 are folded in pairs. As shown in FIG. 4, the pair is composed of a first arm 41A and a second arm 41B that are folded so as to overlap each other when viewed for a side. As shown in FIG. 3, in a plan view, the first arm 41A and the second arm 41B are arranged outside the rectangular space S partitioned by the two first frames 40 and 40 and the two second frames 41 and 41.

According to the aerial vehicle 1 of the present embodiment, by making the second frames 41 and 41 foldable, the horizontal dimension of the airframe can be efficiently reduced, and an aerial vehicle 1 that is easy to use in the field can be provided. Further, the labor required for attaching and detaching the second frames 41 and 41 can be reduced.

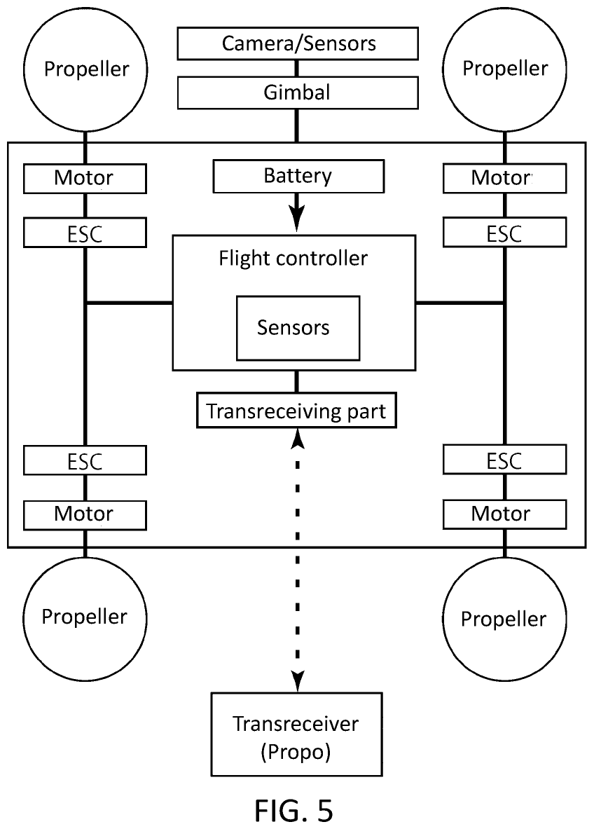

The above-mentioned aerial vehicle has a functional block shown in FIG. 5. Further, the functional block in FIG. 5 has a minimum reference configuration. The flight controller is a so-called processing unit. The processing unit can have one or more processors such as a programmable processor (e.g., a central processing unit (CPU)). The processing unit has a memory (not shown), and can access the memory. The memory stores logic, code, and/or program instructions executable by a processing unit to perform one or more steps. The memory may include, for example, a separable medium such as an SD card or a random access memory (RAM) or an external storage device. Data acquired from a camera and a sensor may be transmitted directly to the memory and stored. For example, still image, dynamic image data taken by a camera or the like is recorded in a built-in memory or an external memory.

The processing unit includes a control module configured to control the state of the aerial vehicle. For example, the control module controls a propulsion mechanism (motor, etc.) of the aerial vehicle in order to adjust the spatial arrangement, velocity, and/or acceleration of the aerial vehicle having six degrees of freedom (translational motions x, y and z, and rotational motions θx, θy and θz). The control module can control one or more of the states of the mounting unit and sensors.

The processing unit can communicate with a transreceiver configured to send and/or receive data from one or more external devices (e.g., a terminal, a display device, or other remote controller). The tranresceiver can use any suitable communication means such as wired or wireless communication. For example, the transreceiving part can use one or more of a local area network (LAN), a wide area network (WAN), infrared, wireless, WIN, point-to-point (P2P) network, telecommunication network, cloud communication, and the like. The transreceiving part can transmit and/or receive one or more of, data acquired by sensors, process results generated by the processing unit, predetermined control data, user command from a terminal or a remote controller, and the like.

Sensors according to the present embodiment may include inertial sensors (acceleration sensors, gyro sensors), GPS sensors, proximity sensors (e.g., LiDAR), or vision/image sensors (e.g., cameras).

The aerial vehicle of the present invention can be expected to be used as an aerial vehicle for delivery services, and to be used as an industrial aerial vehicle in a warehouse or a factory. In addition, the aerial vehicle of the present disclosure can be used in airplane-related industries such as multicopters and drones. Furthermore, the present invention not only can be suitably used as an aerial photography flight vehicle equipped with a camera or the like, but also can be used in various industries such as security, agriculture, and infrastructure monitoring.

The above-described embodiments are merely on examples to facilitate the understanding of the present invention, and are not intended to limit the present invention. The present invention can be changed and modified without departing from the gist thereof, and it goes without saying that the equivalents are included in the present invention.

### First Modification

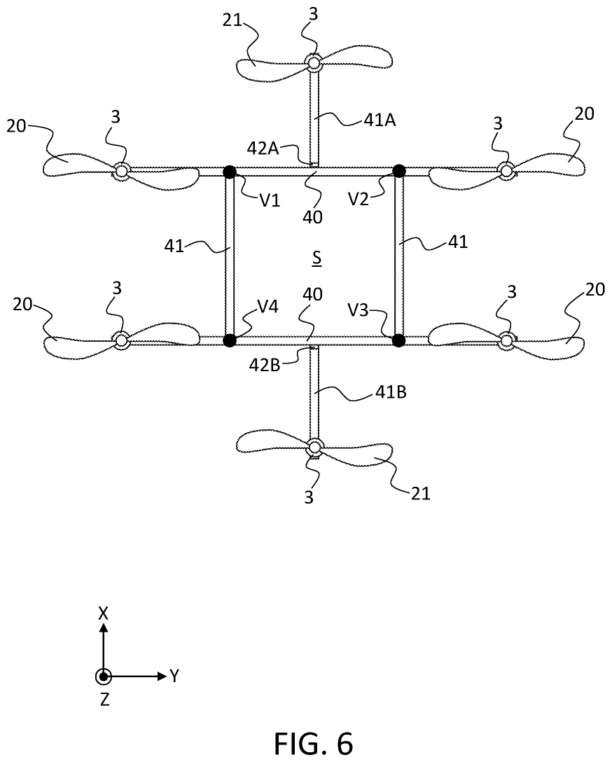

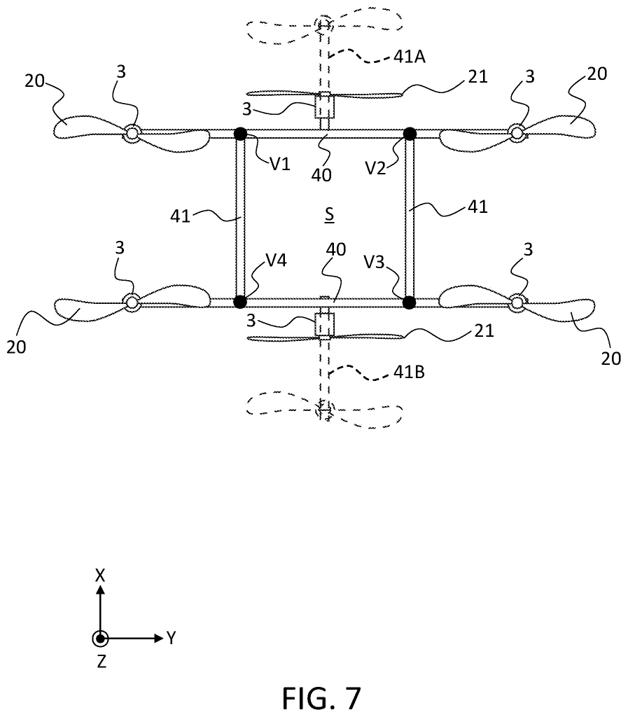

FIGS. 6 and 7 are showing first modifications of the frame structure in an aerial vehicle of the present invention. In this modification, as shown in FIG. 6, with respect to the rectangular space S partitioned by two first frames 40, 40 and two second frames 41, 41, the four vertices of the rectangle of the space S are defined as V1 to V4 in a clockwise direction. As shown in FIG. 6, the frame structure includes a first arm 41A extending in the X direction starting from the midpoint between vertices V1 and V2, and a second arm 41B, which starts from the midpoint between the vertices V3 and V4 and extends in the X direction opposite to the first arm 41A. As shown in FIG. 7, the frame structure is provided with a hinge part 42A in which the first arm 41A can be folded downward and a hinge part 42B in which the second arm 41B can be folded downward. According to the frame structure of this modification, by making the first arm 41A and the second arm 41B foldable, the horizontal dimensions of the airframe can be efficiently reduced, and an aerial vehicle that is easy to use on a work site can be provided. Further, the labor required for attaching and detaching the first arm 41A and the second arm 41B can be reduced.

### Second Modification

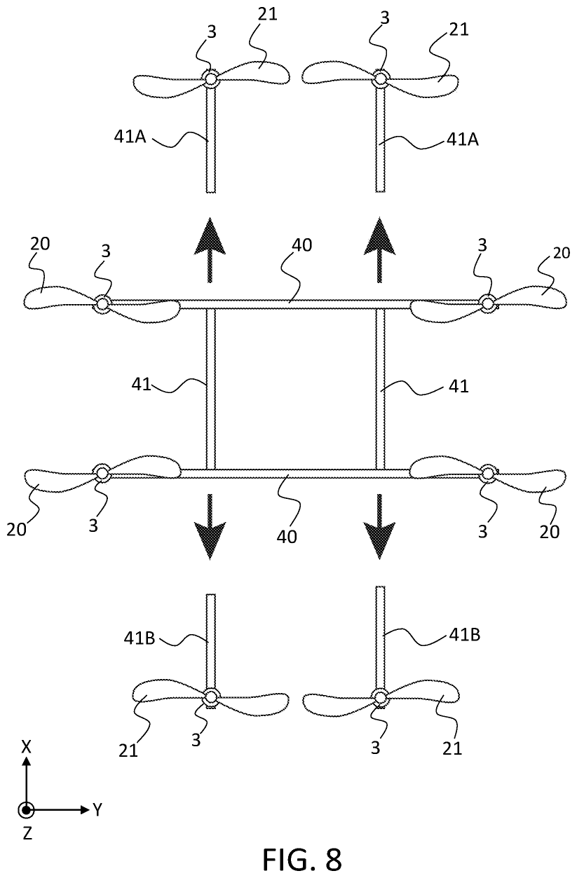

FIG. 8 is showing a second modification of the frame structure in an aerial vehicle of the present invention. In this modification, the first arm 41A is detachably connected to the first frame 40. Similarly, the second arm 41B is also detachably connected to the first frame 40. According to the frame structure of this modification, the first arm 41A and the second arm 41B can be separated from the first frame 40, so that the horizontal dimension of the airframe can be efficiently reduced, and an aerial vehicle that is easy to use on a work site can be provided.

### DESCRIPTION OF REFERENCE NUMERALS

1: aerial vehicle
20: first rotary blade
21: second rotary blade
40: first frame
41: second frame
41A: first arm
41B: second arm
42: hinge part

1. An aerial vehicle comprising:
two first frames arranged in a second direction intersecting a first direction, with the first direction being longitudinal;
two second frames arranged in the first direction by overlapping the two first frames, with the second direction being longitudinal;
first rotor blades mounted to both ends of the first frame; and
second rotor mounted to both ends of the second frame,
wherein the second frame is provided with a hinge part capable of folding the second frame at a midway thereof.

2. The aerial vehicle according to claim 1,
wherein, a pair of the two second frames is at folded positions, and
wherein each of the two folded second frames is comprising a first arm and a second arm respectively and the first arm and the second arm are overlapped each other when viewed for a side.

3. The aerial vehicle as in claim 1,
wherein the two first frames are laid horizontally across the two second frames in a parallel cross pattern.

4. The aerial vehicle as in claim 2,
wherein the two first frames are laid horizontally across the two second frames in a parallel cross pattern.
